(19) United States
(12) Patent Application Publication
(10) Pub. No.: US 2026/0316694 A1
(43) Pub. Date: Oct. 15, 2026

(54) MOBILE DEVICE HOLDER FOR A VEHICLE

(71) Applicant: Re:Car Inc., Troy, MI (US)

(72) Inventors: Aaron Gould, Grosse Pointe Park, MI (US); Tisha Johnson, Douglas, MI (US); David Stuttard, De Pere, WI (US); Raymond Kalisz, Troy, MI (US); Stephen Halonen, Howell, MI (US); Cody Crafts, Troy, MI (US)

(21) Appl. No.: 19/644,334

(22) Filed: Apr. 10, 2026

Related U.S. Application Data
(60) Provisional application No. 63/786,891, filed on Apr. 10, 2025.

(51) Int. Cl. B60R 11/02; B60R 11/00

(52) U.S. Cl. CPC B60R 11/0241; B60R 2011/0005; B60R 2011/0061; B60R 2011/0071

(57) ABSTRACT

A mobile device holder including a left arm comprising a first gear track; a right arm having a second gear track; a carriage positioned between the left and right arms; a first gear engaged with the first gear track and the second gear track such that linear movement of one of the left arm or the right arm causes corresponding linear movement of the other arm; a retracting device coupled to the left and right arms; an upper jaw configured to move linearly relative to the carriage; a second gear engaged with a third gear track of the upper jaw; a third gear fixed to the second gear, the third gear being engaged with a fourth gear track of the left arm such that movement of either the left arm or the right arm causes corresponding movement of the upper jaw.

### CROSS-REFERENCE TO RELATED APPLICATIONS

This application claims priority to US 63/786,891 filed on Apr. 10, 2025, the entirety of which is hereby incorporated by reference herein for all purposes.

### FIELD

These teachings relate to a mobile device holder for a vehicle.

### BACKGROUND

Some vehicle drivers use a holding device to position a mobile device at a location that is easy to access and view. However, many holding devices are not intuitive to use. For example, some holding devices require a user to perform multiple actions to insert the mobile device into the holder and secure the mobile device within the holder. In other holding devices, an excess length of a charging cable used to charge the mobile device may hang from the holder, which can become tangled and does not provide a clean or aesthetically pleasing appearance inside the vehicle.

Other holding devices are limited to holding only a mobile phone. If a driver wishes to mount a larger mobile device, such as a tablet, to a vehicle dashboard, the driver is typically required to purchase a separate holding device designed for a tablet. If the driver wishes to switch between mounting a mobile phone and a tablet on the vehicle dashboard, the driver is typically required to remove the phone holder and replace it with the tablet holder. Such actions may be cumbersome and inconvenient for the driver.

Accordingly, it may be desirable to improve the current state of the art. For example, it may be desirable to provide a mobile device holder that allows a user or driver to insert and secure a mobile device within the holder with a simple, single action. It may also be desirable to provide a mobile device holder that can conceal a charging cable. Further, it may be desirable to provide a single device holder capable of accommodating a variety of mobile device sizes, such as a mobile phone and a tablet.

### SUMMARY

These teachings provide a mobile device holder. The mobile device holder according to these teachings advantageously allows a user or driver to insert and secure a mobile device within the holder with a simple, single action. The mobile device holder according to these teachings further accommodates a charging cable in a manner that conceals the cable from view. Additionally, the mobile device holder according to these teachings is configured to accommodate a variety of mobile device sizes, such as a mobile phone and a tablet.

In an embodiment, a mobile device holder for attaching a mobile device to an accessory rail on a vehicle dashboard is disclosed, the mobile device holder comprising: a left arm comprising a left arm gear track; a right arm comprising a right arm gear track; a carriage arranged between the left arm and the right arm, the carriage configured to support a pinion gear that engages the left arm gear track and the right arm gear track; a retracting device connecting the left arm and the right arm; a locking device configured to maintain a relative spacing between the left arm and the right arm after the mobile device is inserted into the mobile device holder; and an attaching device comprising a cam that is configured to engage a slot on the accessory rail to mount the mobile device holder to the dashboard.

In some embodiments, the left arm and the carriage are configured to move away from the right arm during insertion of the mobile device into the mobile device holder; during the insertion of the mobile device into the mobile device holder, the pinion gear rotates and the retracting device expands as the left arm and the carriage are moved in a direction away from the right arm; the carriage comprises an opening through which a plug of a mobile device charger extends, the plug moves with the carriage and the left arm during insertion of the mobile device into the mobile device holder; after the mobile device is removed from the mobile device holder, the pinion gear rotates and the retracting device moves the left arm and the carriage in a direction towards the right arm; the retracting device is a spring that is secured to the left arm and to the right arm; the spring is received into a channel or recess defined on a back side of the left arm and channel or recess defined on a front side of the right arm; the right arm does not move relative to the left arm and carriage during the insertion and the removal of the mobile device from the mobile device holder; the locking device comprises a locking tab that engages one or more locking grooves in the right arm; the carriage comprises a lower region and the locking tab is defined at one side of the lower region; the mobile device is configured to engage the locking device after the mobile device is received into the mobile device holder and push the locking tab into the one or more locking grooves to maintain the relative spacing between the left arm, the carriage, and the right arm; the carriage comprises a spindle, hub, or bearing that engages the pinion gear; the carriage comprises an upper region having an overhang that partially surrounds an upper part of the left arm and an upper part of the right arm; the mobile device holder comprises a base, the base comprises a first projection and a second projection, the first projection engages a slot defined on the left arm and the second projection engages a slot defined on the right arm; the left arm has an L-shaped cross section and the right arm has an L-shaped cross section; the carriage has a Z-shaped cross section or an S-shaped cross section; the mobile device holder comprises a ball and socket joint configured to allow the mobile device holder to pivot relative to the slot; the attaching device further comprises a key, wherein the cam is configured to engage the slot on the accessory rail and the key is configured to move the cam to engage a wall of the accessory rail; the mobile device from the mobile device holder is configured to disengage the locking device and release the locking tab from the one or more locking grooves so that spacing between the left arm, the carriage, and the right arm may change; the base is removable from the carriage; the left arm and the carriage are moved in a direction away from the right arm, the carriage is maintained in a position substantially equidistant between the left arm and the right arm; or any combination thereof.

In an embodiment, a mobile device holder for attaching a mobile device to an accessory rail on a vehicle dashboard is disclosed, the mobile device holder comprising: a left arm comprising a left gear track; a right arm; a middle body between the left arm and the right arm, the middle body comprising a right gear track; a carriage assembly comprising a first carriage and a second carriage, the first carriage configured to support a pinion gear that engages the left gear track and the right gear track; a retracting device connecting the left arm to the carriage assembly and the right arm to the carriage assembly; a locking device configured to maintain a relative spacing between the left arm and the right arm after the mobile device is inserted into the mobile device holder; and an attaching device configured to engage a slot on the accessory rail to mount the mobile device holder to the dashboard.

In some embodiments, left arm and the carriage assembly are configured to move away from the right arm during insertion of the mobile device into the mobile device holder; during the insertion of the mobile device into the mobile device holder, the pinion gear rotates and the retracting device expands as the left arm and the carriage assembly are moved in a direction away from the right arm; one or both of the first carriage and the second carriage comprise an opening through which a plug of a mobile device charger extends, the plug moves with the carriage assembly and the left arm during insertion of the mobile device into the mobile device holder; after the mobile device is removed from the mobile device holder, the pinion gear rotates and the retracting device moves the left arm and the carriage assembly in a direction towards the right arm; the locking device comprises a locking tab that engages one or more locking grooves in the middle body; the first carriage comprises a lower region and the locking tab is defined at one side of the lower region; the mobile device is configured to engage the locking device after the mobile device is received into the mobile device holder and push the locking tab into the one or more locking grooves to maintain the relative spacing between the left arm, the carriage assembly, and the right arm; the mobile device holder comprises a moveable arm between the left arm and the right arm, the moveable arm is configured to pivot between a stowed position and an in-use position, wherein in the in-use position, the moveable arm extends upwardly between the left arm and the right arm; in the stowed position, the moveable arm lays flat; or any combination thereof.

A mobile device holder for attaching a mobile device to an accessory rail on a vehicle dashboard, the mobile device holder comprising :a left arm comprising a first gear track; a right arm comprising a second gear track; a carriage positioned between the left arm and the right arm and configured to support a rear surface of the mobile device; a first gear engaged with the first gear track and the second gear track such that linear movement of one of the left arm or the right arm causes corresponding linear movement of the other of the left arm or the right arm; a retracting device coupled to the left arm and the right arm and configured to bias the left arm and the right arm toward one another; an upper jaw configured to move linearly relative to the carriage; a second gear engaged with a third gear track of the upper jaw; a third gear fixed to the second gear such that the second gear and the third gear rotate together, the third gear being engaged with a fourth gear track of the left arm such that movement of either the left arm or the right arm causes corresponding movement of the upper jaw; and an attaching device configured to engage the accessory rail.

A mobile device holder for attaching a mobile device to an accessory rail on a vehicle dashboard, the mobile device holder comprising: a left arm comprising a lower gear track and an upper gear track, the lower gear track and the upper gear track each comprising linear teeth arranged in a rack configuration; a right arm comprising a gear track comprising linear teeth arranged in a rack configuration; a first gear simultaneously engaged with the lower gear track of the left arm and the gear track of the right arm such that linear lateral movement of either the left arm or the right arm causes rotation of the first gear and corresponding linear lateral movement of the other arm; a retracting device coupled between the left arm and the right arm and configured to bias the arms toward one another; a support plate fixed relative to the carriage and comprising guiding features; an upper jaw configured to move linearly in a vertical direction relative to the support plate and constrained by the guiding features to prevent tilting, the upper jaw comprising a gear track; a second gear engaged with the gear track of the upper jaw; a third gear fixed coaxially with the second gear such that the second gear and the third gear rotate together about a common axis, the third gear being engaged with the upper gear track of the left arm; wherein movement of either the left arm or the right arm causes rotation of the first gear, corresponding movement of the left arm, rotation of the third gear and the second gear, and vertical movement of the upper jaw; and an attaching device comprising a cam configured to engage a slot of the accessory rail.

### BRIEF DESCRIPTION OF THE DRAWINGS

FIG. 1 is a perspective view of a vehicle dashboard and includes a mobile device holder according to these teachings.

FIG. 2 is a perspective view of a mobile device holder.

FIG. 3 is a front exploded perspective view of the mobile device holder of FIG. 2.

FIG. 4 is a rear exploded perspective view of the mobile device holder of FIG. 2.

FIG. 5 is a partially exploded view of the mobile device holder of FIG. 2.

FIG. 6 is a perspective view of the mobile device holder of FIG. 2.

FIG. 7 is a perspective view of the mobile device holder of FIG. 2 and the vehicle dashboard.

FIG. 8 is a perspective view of a vehicle dashboard and includes a mobile device holder according to these teachings.

FIG. 9 is a perspective view of a mobile device holder.

FIG. 10 is a front exploded perspective view of the mobile device holder of FIG. 9.

FIG. 11 is a rear exploded perspective view of the mobile device holder of FIG. 9.

FIG. 12 is a perspective view of the mobile device holder of FIG. 9.

FIG. 13 is a perspective view of the mobile device holder of FIG. 9 holding a mobile device.

FIG. 14 is a perspective view of the mobile device holder of FIG. 9 holding two mobile devices.

FIG. 15 is a perspective view of the mobile device holder of FIG. 9 holding a mobile device.

FIG. 16 is a perspective view of a mobile device holder.

FIG. 17A is a front exploded perspective view of the mobile device holder of FIG. 16.

FIG. 17B is a rear exploded perspective view of the mobile device holder of FIG. 16.

FIG. 18A is a front perspective view of the mobile device holder of FIG. 16 with the arms in a closed or engaged configuration.

FIG. 18B is a rear perspective view of the mobile device holder of FIG. 16 with the arms in a closed or engaged configuration.

FIG. 19A is a front perspective view of the mobile device holder of FIG. 16 with the arms in an open or disengaged configuration.

FIG. 19B is a rear perspective view of the mobile device holder of FIG. 16 with the arms in an open or disengaged configuration.

FIG. 20A is a perspective view of the mobile device holder.

FIG. 20B is a perspective view of the mobile device holder with the base removed.

FIG. 21 illustrates a vehicle in a first or pickup truck configuration.

FIG. 22 illustrates a vehicle in a second or SUV configuration.

### DETAILED DESCRIPTION

The mobile device holder according to these teachings is configured and enabled to accommodate a variety of mobile devices and/or mobile device sizes, such as various sized mobile phones and tablets. This is accomplished at least in part by the mobile device holder having at least one arm that is moveable (e.g., expandable and retractable) to accommodate the various mobile devices having different or varying widths or sizes. In the illustrated example, the holder comprises a pinion gear that is arranged between two gear tracks. Upon insertion of a mobile device into the mobile device holder, the pinion gear rotates and at least one of the arms moves away from the other arm to accommodate a larger mobile device. Upon removal of the mobile device from the holder, a retracting device is configured to move, pull, or draw the arm(s) back into a steady state configuration so the holder is ready to accept another device or a smaller sized device.

In another example, a mobile device holder for attaching a mobile device to an accessory rail on a vehicle dashboard is disclosed. The mobile device holder comprising: a left arm comprising a first gear track; a right arm comprising a second gear track; a carriage positioned between the left arm and the right arm and configured to support a rear surface of the mobile device; a first gear engaged with the first gear track and the second gear track such that linear movement of one of the left arm or the right arm causes corresponding linear movement of the other of the left arm or the right arm; a retracting device coupled to the left arm and the right arm and configured to bias the left arm and the right arm toward one another; an upper jaw configured to move linearly relative to the carriage; a gear engaged with a third gear track of the upper jaw; another gear fixed to the third gear such that the second gear and the third gear rotate together about a common axis, the gear being engaged with a gear track of the left arm such that linear movement of the left arm causes rotation of the second gear and the third gear and corresponding linear movement of the upper jaw; and an attaching device comprising a cam configured to engage a slot on the accessory rail to mount the mobile device holder to the vehicle dashboard.

The mobile device holder may be configured so that the plug or cable for charging or connecting the mobile device to the vehicle maintains a substantially centered relationship relative to the arms to ensure it aligns with a corresponding port on the mobile device, regardless of the spacing or positioning of the arms. This may be accomplished by arranging the plug in a carriage. The carriage is moveable relative to one or both of the arms when the arms are being expanded or retracted to accommodate a larger or smaller sized mobile device. The carriage maintains a substantially centered relationship relative to the arms. This helps ensure that no matter what size mobile device is inserted into the holder, the plug can engage the reciprocal of the mobile device.

The plug may have an L-shaped configuration. The plug may comprise a USB connector, such as a USB-C connector, or another suitable connector configured to interface with a corresponding port of the mobile device. In some embodiments, the plug may be removable and replaceable to accommodate different connector types.

A cable or wire associated with the plug may be routed through or along portions of the mobile device holder, such as behind the carriage, within the base, or both, to reduce visibility and manage excess cable length. The plug may be positioned relative to the carriage such that, when a mobile device is received within the holder, the plug is aligned with and engages the port of the mobile device.

The mobile device holder comprises one or more retracting devices. A retracting device may function to return the arms of the mobile device holder into a retracted or steady state configuration. The one or more retracting devices may be one or more springs or other elastic devices. The retracting device is configured to move the arms into a smaller configuration and to maintain tension against the sides of the mobile device. This helps ensure the arms are against the sides of the mobile device to prevent it from falling out of the holder.

The mobile device holder according to these teachings may be configured to meet one or more vehicle safety standards. In some embodiments, the mobile device holder is configured to comply with FMVSS 201 S5.3.1 relating to occupant protection during interior impact events. For example, the configuration, material selection, and structural interaction of the retracting device, the one or more arms, the carriage, the upper jaw, and/or combinations thereof may be arranged to reduce injury risk and maintain retention of the mobile device during such events.

In some configurations, the retracting device and the arms are configured to co-act to maintain a clamping force on the mobile device sufficient to resist displacement under inertial loading conditions experienced during vehicle impact or sudden deceleration. For example, the retracting device may be configured to bias the arms toward one another with sufficient force such that the mobile device remains secured when subjected to inertial loads of at least about 10g in a horizontal transverse direction and at least about 10g in a vertical direction. In other configurations, the retracting device may maintain retention under inertial loads of at least about 20g in the horizontal transverse direction and at least about 20g in the vertical direction.

In further configurations, the mobile device holder may be configured to withstand inertial loads of at least about 30g in a longitudinal direction (e.g., forward or rearward relative to the vehicle), while maintaining engagement between the arms and the mobile device. The coordinated interaction between the retracting device, arms, carriage, and upper jaw may distribute loads and maintain alignment of the mobile device during such events.

The mobile device holder comprises one or more arms. The one or more arms may be made of a suitable material such as a plastic or composite. For example, the one or more arms (and/or other features like the carriage, base, pinion gear, etc.) may be made of a plastic, polypropylene, nylon, or like material. The one or more arms (and/or other features like the carriage, base, pinion gear, etc.) may be made of a 3D printed material or associated process.

The one or more arms may have a C- or an L-shape configuration, structure, or cross section. The one or more arms or elements of the arms (e.g., the vertical and/or horizontal extensions) may have a C- or U-shaped cross section.

The arms, or any other suitable component of the mobile device holder, may comprise one or more channels or slots for the retracting device. The one or more channels or slots may be located on the back side of the back walls, the front side of the back walls, or both. The channels may be located on the same side (e.g., both on the front side of the left and right back walls, or both on the back side of the left and right back walls). The channels may be located above or below the respective gear tracks, which may be on the left and right arms or on any other suitable component of the mobile device holder.

The locking device may comprise locking grooves or channels on the left arm, the right arm, or both, or on any other suitable component of the mobile device holder. In other words, while an illustrated example shows the locking grooves or channels on the right arm, the locking grooves or channels may also or may instead be located on the left arm. Accordingly, while an illustrated example shows the locking tab on the right side of the carriage, the locking tab may also or may instead be located on the left side of the carriage.

The upper jaw may comprise a plate configured to engage and support a top or upper end of the mobile device. The left arm and the right arm may be configured to engage and support one or more of a bottom portion and opposing side portions of the mobile device. In this manner, the upper jaw, the left arm, and the right arm cooperate to provide a multi-point retention arrangement for securing the mobile device within the holder.

Such a multi-point retention arrangement may advantageously improve stability of the mobile device during vehicle operation. For example, the mobile device may be more securely retained during vehicle accelerations, decelerations (e.g., braking), turning maneuvers, or other dynamic conditions, including sudden or high-magnitude events such as abrupt stops or collisions. The coordinated engagement of the upper jaw and the arms may also reduce relative movement of the mobile device within the holder, thereby improving visibility of the device display and reducing the likelihood of unintended disengagement.

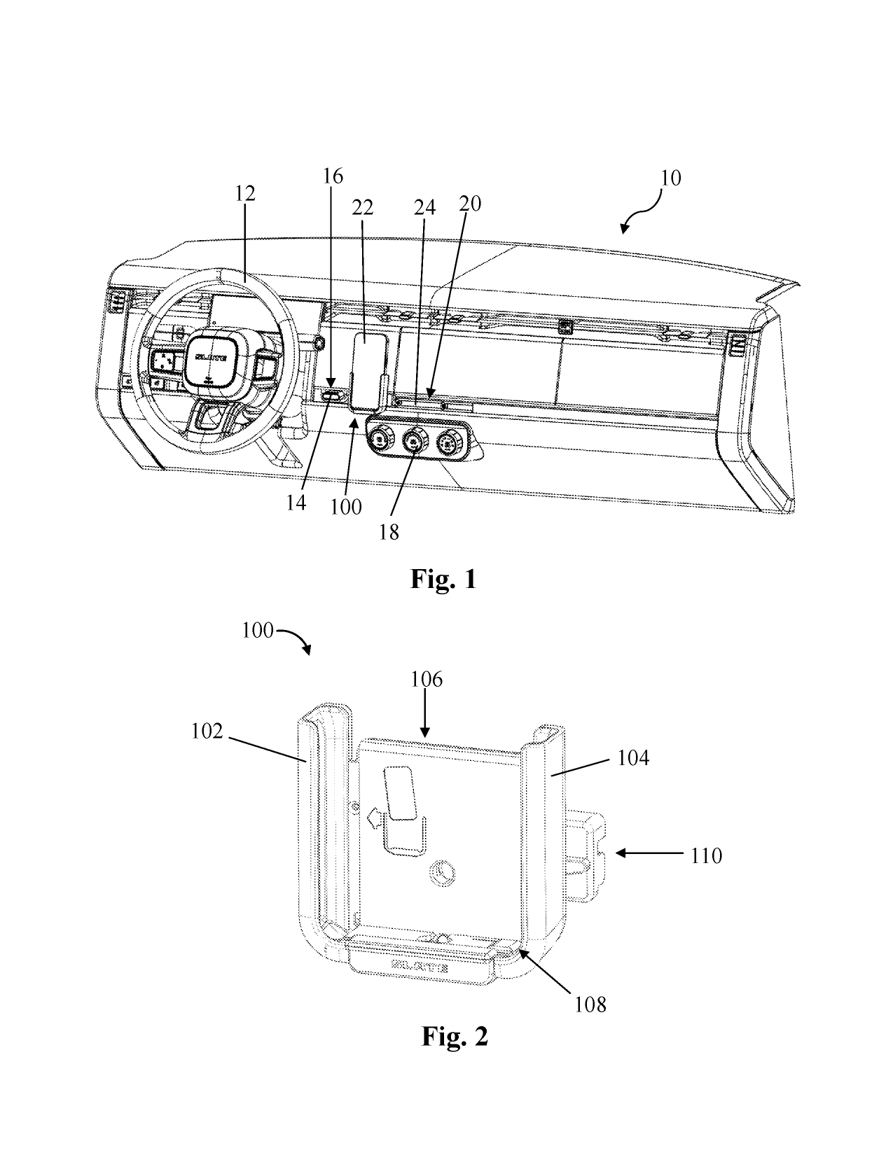

FIG. 1 illustrates a vehicle dashboard 10. The dashboard 10 generally comprises a steering wheel 12, a key 14 that is received into an ignition receptacle 16, HVAC controls 18, and an accessory rail 20. The accessory rail 20 may be on the vehicle dashboard 10 and configured for one or more accessories, such as a mobile device holder 100, to be mounted thereto. The mobile device holder 100 may be configured to hold and position a mobile device 22, such as a mobile phone or tablet, at the vehicle dashboard 10 at a location that is easy for a driver to access and read the display.

With additional reference to FIG. 2, the mobile device holder 100 generally comprises a left arm 102, a right arm 104, a carriage 106 arranged between the left arm 102 and the right arm 104, a locking device 108 configured to maintain a relative spacing between the left arm 102 and the right arm 104 after the mobile device 22 is inserted into the mobile device holder 100, and an attaching device 110 that is configured to engage a slot 24 (see FIGS. 1, 7, 8, 13, 14) on the accessory rail 20 to attach or mount the mobile device holder 100 to the dashboard 10 or accessory rail 20.

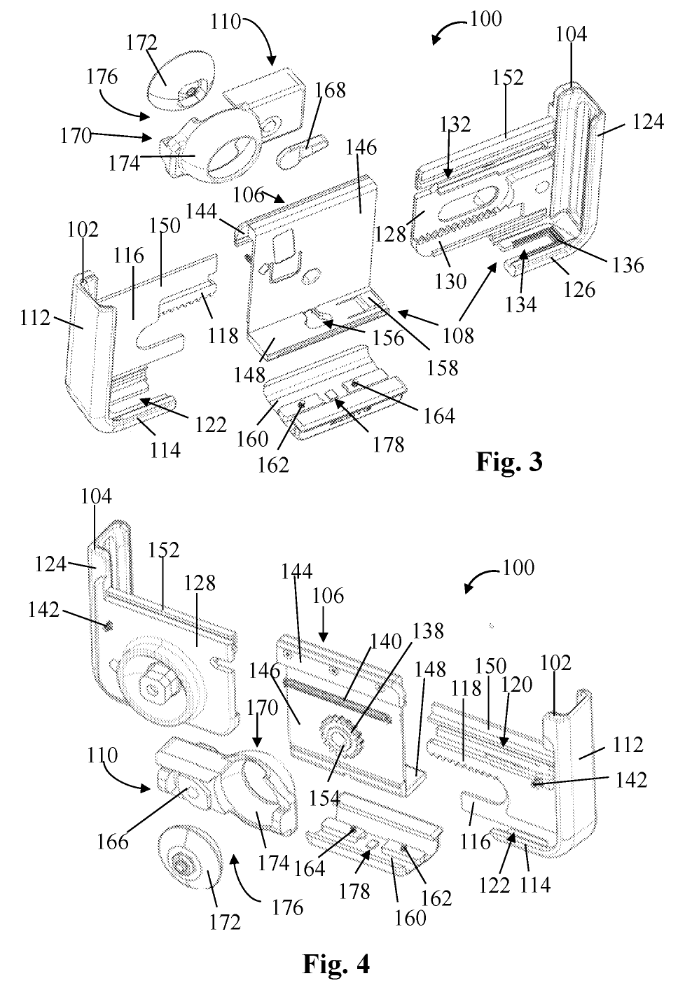

With additional reference to FIGS. 3 and 4, the left arm 102 generally has a C- or L-shape configuration defined by an upright or vertical extension 112 and a lower or horizontal extension 114. A back wall 116 extends between and is connected to the extensions 112, 114. The left arm 102 comprises a left arm gear track 118 and a left arm channel or recess 120. The lower or horizontal extension 114 may comprise a slot or channel 122.

The right arm 104 generally has a C- or L-shape configuration defined by an upright or vertical extension 124 and a lower or horizontal extension 126. A back wall 128 extends between and is connected to the extensions 124, 126. The right arm 104 comprises a right arm gear track 130 and a right arm channel or recess 132. The lower or horizontal extension 126 may comprise a slot or channel 134 and one or more locking grooves 136 that are configured to be engaged by the locking device 108 described further below.

A pinion gear 138, that is supported by the carriage 106, engages the left arm gear track 118 and the right arm gear track 130.

The mobile device holder 100 comprises a retracting device 140 connecting the left arm 102 and the right arm 104. In an assembled configuration, the retracting device 140, which may be a spring or other biasing device, may be secured to the left arm 102 and to the right arm 104 via one or more fasteners or projections 142. The retracting device 140 may be received into the left arm channel or recess 120 and the right arm channel or recesses 132. The retracting device 140 may be enabled to expand and contract within the recesses 120, 132 during insertion and removal of the mobile device 22 from the holder 100.

The carriage 106 may comprise an upper region 144 or overhang, an intermediate wall 146, and a lower region 148. When viewed in cross section, these features 144, 146, 148 may have an S- or Z- shaped cross section. In an assembled configuration, the upper region overhangs 144 at least partially surrounds an upper part 150 of the back wall 116 of the left arm 102 and an upper part 152 of the back wall 128 of the right arm 104. During insertion and removal of the mobile device 22 from the holder 100, the overhang 144 may move or slide relative to or against the upper parts 150, 152 or arms 102, 104. The overhang 144 surrounding the arms 102, 104 assists in maintaining alignment of the left and right arms 102, 104.

The intermediate connecting wall 146 of the carriage 106 may have a spindle, hub, or bearing 154 that engages or supports the pinion gear 138. During insertion and removal of the mobile device 22 from the holder 100, the pinion gear 138 can move or rotate about or around the spindle, hub, or bearing 154.

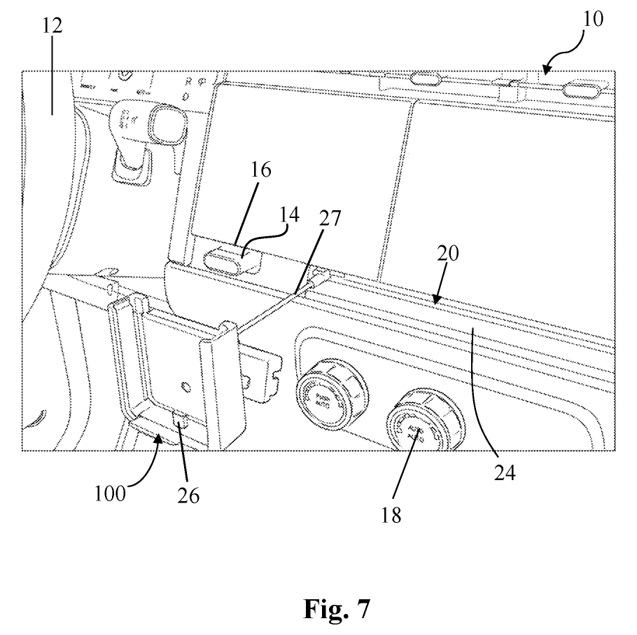

The lower region 148 of the carriage 106 comprises an opening 156 through which a plug or cable 26 (FIG. 7) may extend for connecting the mobile device 22 to the vehicle (e.g., electronics in the dashboard 10).

The lower region of the 148 of the carriage 106 comprises a locking tab 158, which may be part of the locking device 108, that is configured to be biased into an engaged position and engage one or more of the locking grooves or channels 136, which may also be part of the locking device 108, defined in the right arm 104.

The locking tab 158 is configured to be moved or biased into the engaged position under the weight of the mobile device 22 as it is inserted into the holder 100. Upon removal of the mobile device 22 from the holder 100, the tab 158 is configured to flex or retract back into an unengaged position and out of engagement with one or more of the grooves 136.

The mobile device holder 100 comprises a base 160. The base 160 may be configured to engage the lower region 148 of the carriage 106. The base 160 may be connected to the carriage 106 or to the lower region 148 of the carriage 106 via one or more fasteners. The base 160 may be separatable from the carriage or other features and replaceable with another base for customizing the holder 100 (e.g., different colors, patterns, materials, openings for plugs, etc.).

The base 160 comprises a left projection 162 that is configured to be received into the left channel or slot 122 in the left arm 102, and a right projection 164 that is configured to be received into the right channel or slot 134 defined in the right arm 104. The engagement of the projections 162, 164 into the respective slots 122, 134 assists in maintaining alignment of the left and right arms 102, 104.

The attaching device 110 is configured to engage a slot 24 on the accessory rail 20 to attach or mount the mobile device holder 100 to the dashboard 10. The attaching device 110 comprises a cam 166 that can be actuated by a key 168. Upon insertion of the cam 166 into the slot 24 on the accessory rail 20, the key 168 can be actuated by a user or driver to cause the cam 166 to move into engagement with the walls of the slot 24 to lock the mobile device holder 100 to the rail 20. The key 168 can be actuated by a user or driver to cause the cam 166 to move out of engagement with the walls of the slot 24 to unlock lock the mobile device holder 100 from the rail 20 to move the holder 100 into a different position along a length of the rail 20 or to separate the holder 100 from the rail 20.

The mobile device holder 100 comprises an articulating device 170. The articulating device comprises a ball 172 and socket 174 defining a ball and socket joint 176 that can be moved to adjust a position of the mobile device 22 relative to the user or driver for better viewing or interaction with the mobile device.

The ball 172 may be at least partially received within the socket 174 such that the joint 176 allows selective rotation, pivoting, and angular adjustment of the mobile device 22 relative to a user or driver for improved viewing, accessibility, and interaction.

In some configurations, the ball-and-socket joint 176 may allow rotation about one or more axes. The joint 176 may be configured to permit movement of at least about 5 degrees, 10 degrees, 15 degrees, 20 degrees, or 30 degrees or more in one or more directions, and in certain embodiments, may permit substantially omnidirectional adjustment.

Advantageously, the ball-and-socket joint 176 enables a user to quickly and intuitively reposition the mobile device 22 to a desired viewing angle, thereby improving ergonomics, visibility, and safety during use.

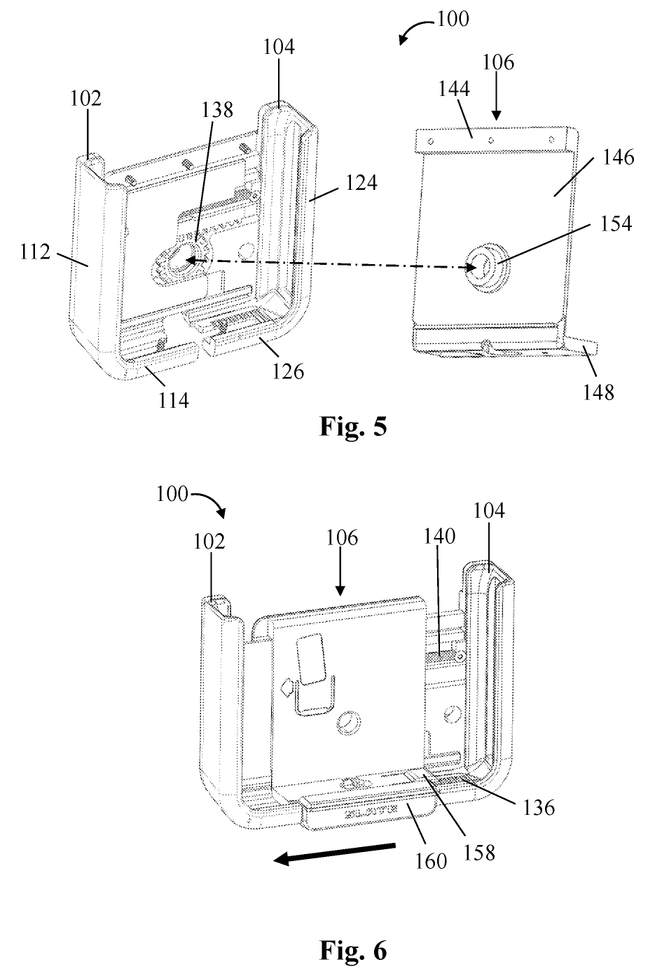

Referring to FIGS. 1-7, a user may connect the cable 26 to an electrical receptacle or component at the vehicle dashboard 10. The cable 26 may extend through an aperture 178 defined in the carriage 106 or base 160 and extend into the opening 156 in the carriage 106. Accordingly, the cable 26 may be concealed from view and not dangle below the mobile device 22 and holder 100.

A user may align the cam 166 into the slot 24 and actuate the key 168 to engage the edges or surfaces of the cam 166 against the walls or structure of the slot 24. This may lock the holder 100 into place and prevent it from moving along the slot 24.

A user may insert a mobile device 22 into the mobile device holder 100 by inserting into the U-shaped open end of the holder 100, between the left and right arms 102, 104. In a steady state position, before the mobile device 22 is inserted into the holder, the spacing between the arms 102, 104 may be at least slightly smaller than a width of the mobile device 22.

Accordingly, during insertion, the mobile device 22 may push the left arm 102 and carriage 106 away from the right arm 104. During this movement, the carriage 106 maintains a substantially centered relationship between the two arms 102, 104 so that the cable or plug through the opening 156 is generally centered between the two arms 102, 104. During the movement of the left arm 102, the pinion gear 138 rotates about the hub 154 along gear tracks 118, 130. During the insertion of the mobile device 22 into the mobile device holder 100, the pinion gear 138 rotates and the retracting device 140 expands as the left arm 102 and the carriage 106 are moved in a direction away from the right arm 104 according to the arrow in FIG. 6.

Once the mobile device is in the lower most position and in contact with the locking tab 158, the weight of the mobile device 22 pushes the locking tab 158 to engage one or more of the locking grooves 136 on the right arm 104. Accordingly, the left and right arms 102, 104 are restricted from moving relative to one another and the mobile device 22 is thereby secure and held by the arms 102, 104. Accordingly, the mobile device holder 100 according to these teachings advantageously allows a user or driver to insert and secure a mobile device within the holder with a simple, single action without having to perform additional actions or movements after inserting the mobile device into the holder to secure it in place.

Once the mobile device is in the lower most position and in contact with the locking tab 158, the plug or cable can also engage the mobile device 22 to charge or connect the mobile device 22 to the vehicle electronics.

Upon removal of the mobile device 22 from the holder 100, the locking tab 158 is disengaged from the one or more locking grooves 136 and the retracting device 140 may retract and move the left arm 102 and carriage 106 back towards the right arm 104. Upon, during, or after the mobile device 22 is removed from the mobile device holder 100, the pinion gear 138 rotates and the retracting device 140 moves or pulls the left arm 102 and the carriage 106 in a direction towards the right arm 104. The right arm 104 does not move relative to the left arm 102 and carriage 106 during the removal of the mobile device 22 from the mobile device holder 100.

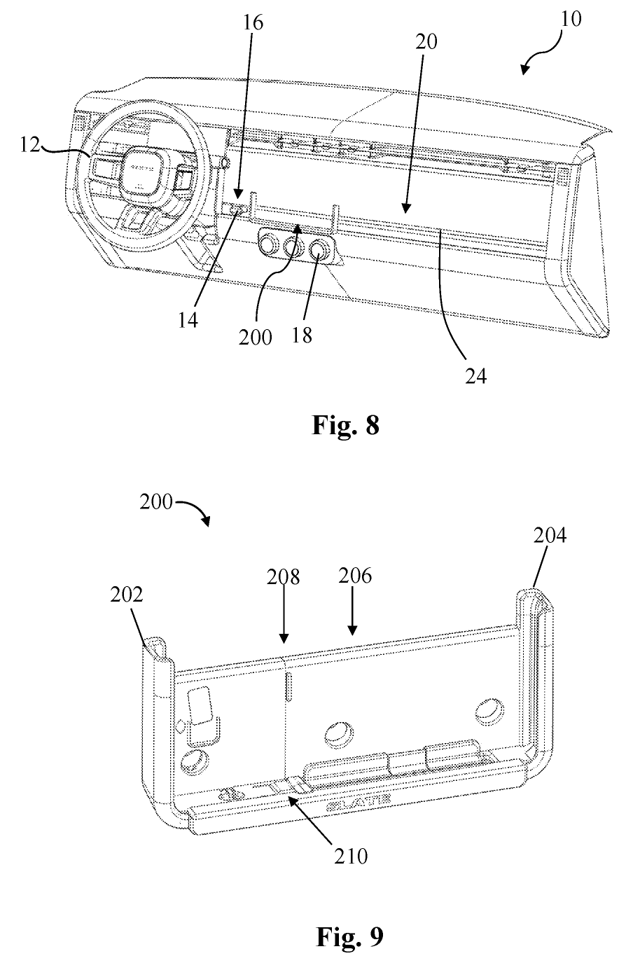

FIG. 8 illustrates a vehicle dashboard 10. The dashboard 10 generally comprises a steering wheel 12, a key 14 that is received into an ignition receptacle 16, HVAC controls 18, and an accessory rail 20. The accessory rail 20 may be on the vehicle dashboard 10 and configured for one or more accessories, such as a mobile device holder 200, to be mounted thereto. The mobile device holder 200 may be configured to hold and position a mobile device 22, such as a mobile phone or tablet, at the vehicle dashboard 10 at a location that is easy for a driver to access and read the display.

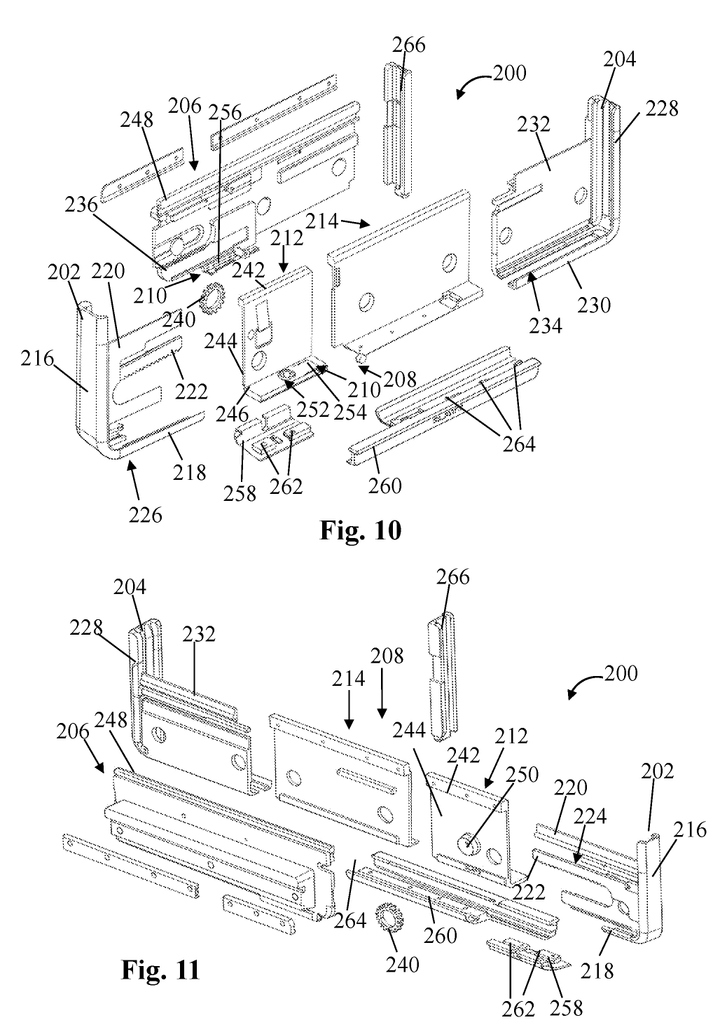

With additional reference to FIG. 9, the mobile device holder 200 generally comprises a left arm 202, a right arm 204, a middle body 206 and a carriage assembly 208 arranged between the left arm 202 and the right arm 204, and a locking device 210 configured to maintain a relative spacing between the left arm 202 and the right arm 204 after the mobile device 22 is inserted into the mobile device holder 200. The carriage assembly 208 may comprise a first carriage 212 and a second carriage 214 (see FIGS. 10, 11).

The mobile device holder 200 may also include one or more attaching devices (like the one illustrated at FIG. 2, et al. at reference 110) that is configured to engage a slot 24 (See FIGS. 1, 7, 14) on the accessory rail 20 to attach or mount the mobile device holder 200 to the dashboard 10. The mobile device holder 200 may also include an articulating device (like the one illustrated at FIGS. 3 and 4, et al. at reference 170).

With additional reference to FIGS. 10 and 11, the left arm 202 generally has an L-shape configuration defined by an upright or vertical extension 216 and a lower or horizontal extension 218. A back wall 220 extends between and is connected to the extensions 216, 218. The left arm 202 comprises a left gear track 222 and a left arm channel or recess 224. The lower or horizontal extension 218 may comprise a slot or channel 226.

The right arm 204 generally has an L-shape configuration defined by an upright or vertical extension 228 and a lower or horizontal extension 230. A back wall 232 extends between and is connected to the extensions 228, 230. The lower or horizontal extension 226 may comprise a slot or channel 234.

The middle body 206 comprises a right gear track 236.

A pinion gear 240, that is supported by the first carriage 212, engages the left gear track 222 and the right gear track 236.

The first carriage 212 may comprise an upper region 242 or overhang, an intermediate wall 244, and a lower region 246. When viewed in cross section, these features 242, 244, 246 may have an S- or Z- shaped cross section. In an assembled configuration, the upper region overhang 242 at least partially surrounds an upper part 248 of the middle body 206 and upper parts of the arms 202, 204. During insertion and removal of the mobile device 22 from the holder 200, the overhang 244 may move or slide relative to or against the upper part 248 and the arms 202, 204. The overhang 242 surrounding the upper part of the arms and middle body assists in maintaining alignment of the left and right arms 202, 204 and middle body 206.

The intermediate wall 244 of the first carriage 212 may have a spindle, hub, or bearing 250 that engages or supports the pinion gear 240. During insertion and removal of the mobile device 22 from the holder 200, the pinion gear 240 can move or rotate about or around the spindle, hub, or bearing 250.

The lower region 246 of the first carriage 212 comprises an opening 252 through which a plug or cable (FIG. 7) may extend for connecting the mobile device 22 to the vehicle (e.g., electronics in the dashboard 10).

The lower region of the 246 of the first carriage 212 comprises a locking tab 254, which may be part of the locking device 210, that is configured to be biased into an engaged position and engage one or more of the locking grooves or channels 256, which may also be part of the locking device 210, defined in the movable body 206.

The locking tab 254 is configured to be moved or biased into the engaged position under the weight of the mobile device 22 as it is inserted into the holder 200. Upon removal of the mobile device 22 from the holder 200, the tab 254 is configured to flex or retract back into an unengaged position and out of engagement with one or more of the grooves 256.

The second carriage 214 may have a structure that is substantially similar to the first carriage 212 (e.g., comprises an upper region or overhang, an intermediate wall, and a lower region that when viewed in cross section, these features may have an S- or Z- shaped cross section). In an assembled configuration, the upper region overhang of the second carriage 214 at least partially surrounds an upper part 248 of the middle body 206 and an upper parts of the arms 202, 204. During insertion and removal of the mobile device 22 from the holder 200, the overhang may move or slide relative to or against the upper part 248 and the arms 202, 204. The overhang surrounding the upper part of the arms and middle body assists in maintaining alignment of the left and right arms and middle body.

The mobile device holder 200 comprises a first base 258 and a second base 260. The bases 258, 260 may be configured to engage the lower regions of the carriages 212, 214. The bases 258, 260 may be connected to the carriages 214, 216 via one or more fasteners. The bases 258, 260 may be separatable from the carriages 214, 216 or other features and replaceable with another base for customizing the holder 200 (e.g., different colors, patterns, materials, openings for plugs, etc.).

The first base 258 comprises one or more projections 262 that is/are configured to be received into the left channel or slot 226 in the left arm 202. The second base 260 comprises one or more projections 264 that is/are configured to be received into the right channel or slot 234 in the right arm. The engagement of the projections into the respective slots assists in maintaining alignment of the left and right arms 202, 204. A user may insert a mobile device 22 into the mobile device holder 200 by inserting into the U-shaped open end of the holder 200, between the left and right arms 202, 204. In a steady state position, before the mobile device 22 is inserted into the holder, the spacing between the arms 202, 204 may be at least slightly smaller than a width of the mobile device 22.

Accordingly, during insertion, the mobile device 22 may push the left arm 202 and carriage assembly 208 away from the right arm 204. During this movement, the carriage assembly 208 maintains a substantially centered relationship between the two arms 202, 204 so that the cable or plug through the opening is generally centered between the two arms 202, 204. During the movement of the left arm 202, the pinion gear 240 rotates about the hub 250 along gear tracks 222, 236. During the insertion of the mobile device 22 into the mobile device holder 200, the pinion gear 240 rotates and a retracting device (like the one illustrated at FIG. 4, et al. at reference 140) expands as the left arm 202 and the carriage assembly 208 are moved in a direction away from the right arm 204.

Once the mobile device is in the lower most position and in contact with the locking tab 254, the weight of the mobile device 22 pushes the locking tab 254 to engage one or more of the locking grooves 256 on the middle body 206. Accordingly, the left and right arms 202, 204 and middle body 206 and carriages 212, 214 are restricted from moving relative to one another and the mobile device 22 is thereby secure and held by the arms 202, 204. Accordingly, the mobile device holder 200 according to these teachings advantageously allows a user or driver to insert and secure a mobile device 22 within the holder 200 with a simple, single action without having to perform additional actions or movements after inserting the mobile device 22 into the holder 200 to secure it in place.

Once the mobile device 22 is in the lower most position and in contact with the locking tab 254, the plug or cable can also engage the mobile device 22 to charge or connect the mobile device 22 to the vehicle electronics.

Upon removal of the mobile device 22 from the holder 200, the locking tab 254 is disengaged from the one or more locking grooves 256 and the retracting device may retract and move the left arm 202 and carriage assembly 208 back towards the right arm 204. Upon, during, or after the mobile device 22 is removed from the mobile device holder 200, the pinion gear 240 rotates and the retracting device moves or pulls the left arm 202 and the carriage assembly 208 in a direction towards the right arm 204.

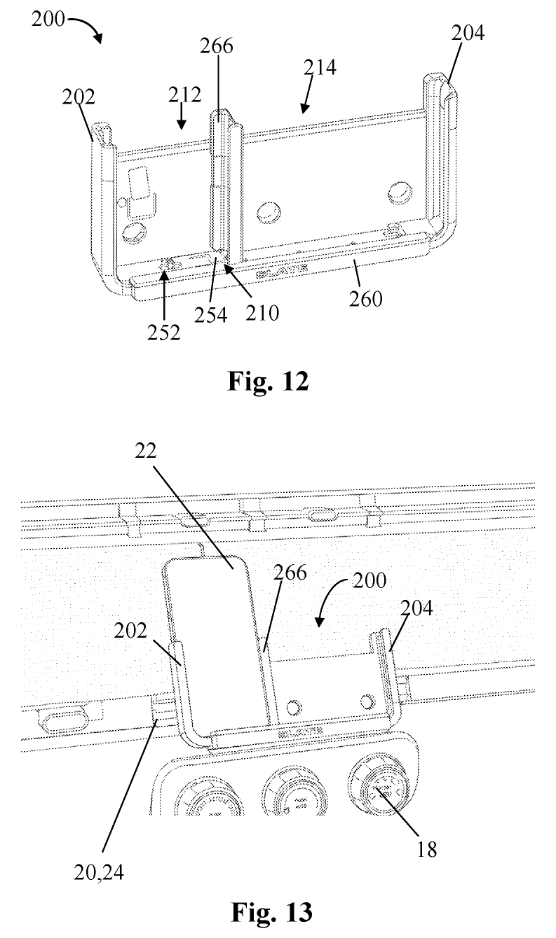

With additional reference to FIGS. 12 and 13, the mobile device holder 200 comprises a moveable arm 266 between the left arm 202 and the right arm 204. The moveable arm 266 is configured to pivot or fold between a stowed position and an in-use position, wherein in the in-use position, the moveable arm 266 extends upwardly between the left arm 202 and the right arm 204, as shown in FIGS. 12 and 13. The moveable arm 266 may function similar to the right arm 104 in the mobile device holder 100 to support a right side of a smaller mobile device such as a mobile phone as illustrated in FIG. 13. In contrast, the moveable arm 266 may be folded downwardly into a stowed position, where the arm 266 is substantially flat or horizontal between the arms 202, 204. In the stowed position, the mobile device holder 200 may be configured to support a larger mobile device, such as a tablet (see FIG. 15).

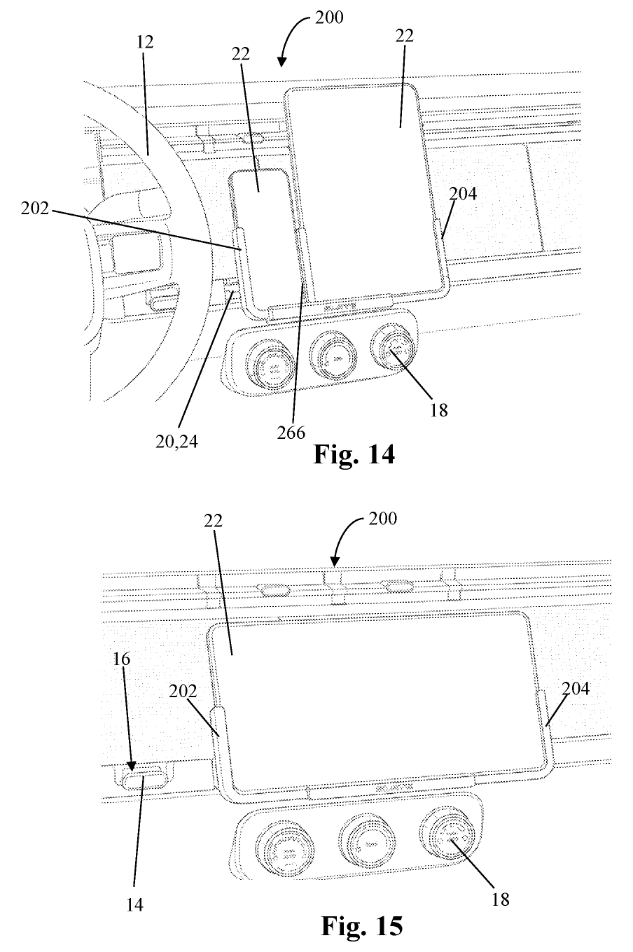

With reference now to FIG. 14, in some configurations, the mobile device holder 200 may accommodate two mobile devices. In FIG. 14, the mobile device holder 200 is shown holding a mobile phone on the left and a tablet on the right. The moveable arm 266 is engaged upwardly to maintain a position of the mobile phone between the left arm 202 and the moveable arm 266. The moveable arm 266 is also engaged against a left side of the tablet and the right arm 204 of the mobile device holder 200 engages a right side of the tablet. Accordingly, the mobile device holder 200 can securely accommodate and hold two mobile devices simultaneously. Such a device holder 200 may be advantageous in situations where a user wishes to support both devices without having to have two discrete holders. Moreover, by turning the moveable arm 266 flat into the stowed position, or upwardly into the in-use position, a user can use the same mobile device holder 200 to support either a smaller mobile device such as a phone or a larger mobile device such as a tablet, without having to change out the entire holder 200. These and other advantages of the mobile device holders according to these teachings can be gleaned by a person having ordinary skill in the art.

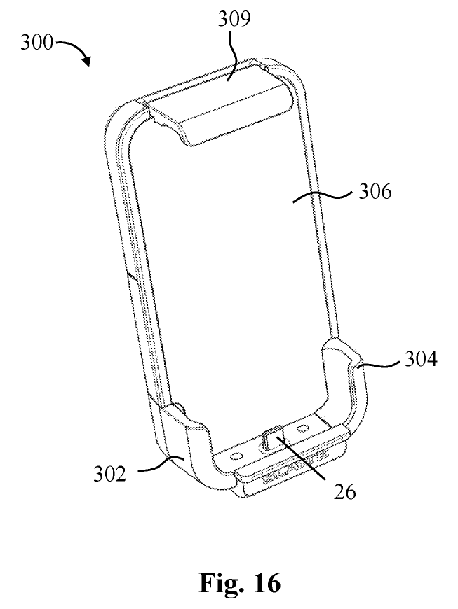

FIG. 16 illustrates a mobile device holder 300 configured to hold, attach, and position a mobile device (e.g., a mobile phone or tablet) at a vehicle dashboard in a location accessible for viewing and interaction by a driver. The holder 300 may be configured to support the mobile device in a stable viewing orientation while permitting quick insertion and removal of the mobile device.

The mobile device holder 300 generally comprises a left arm 302, a right arm 304, a carriage 306, and an upper jaw 309. The carriage 306 may define a rear support surface configured to support a back side of the mobile device. A power cable or connector 26 may extend through an aperture defined in the carriage 306 such that the cable 26 is routed through the holder 300 and is substantially concealed from view. In some embodiments, the cable or connector 26 may be removable and replaceable to accommodate different connector types.

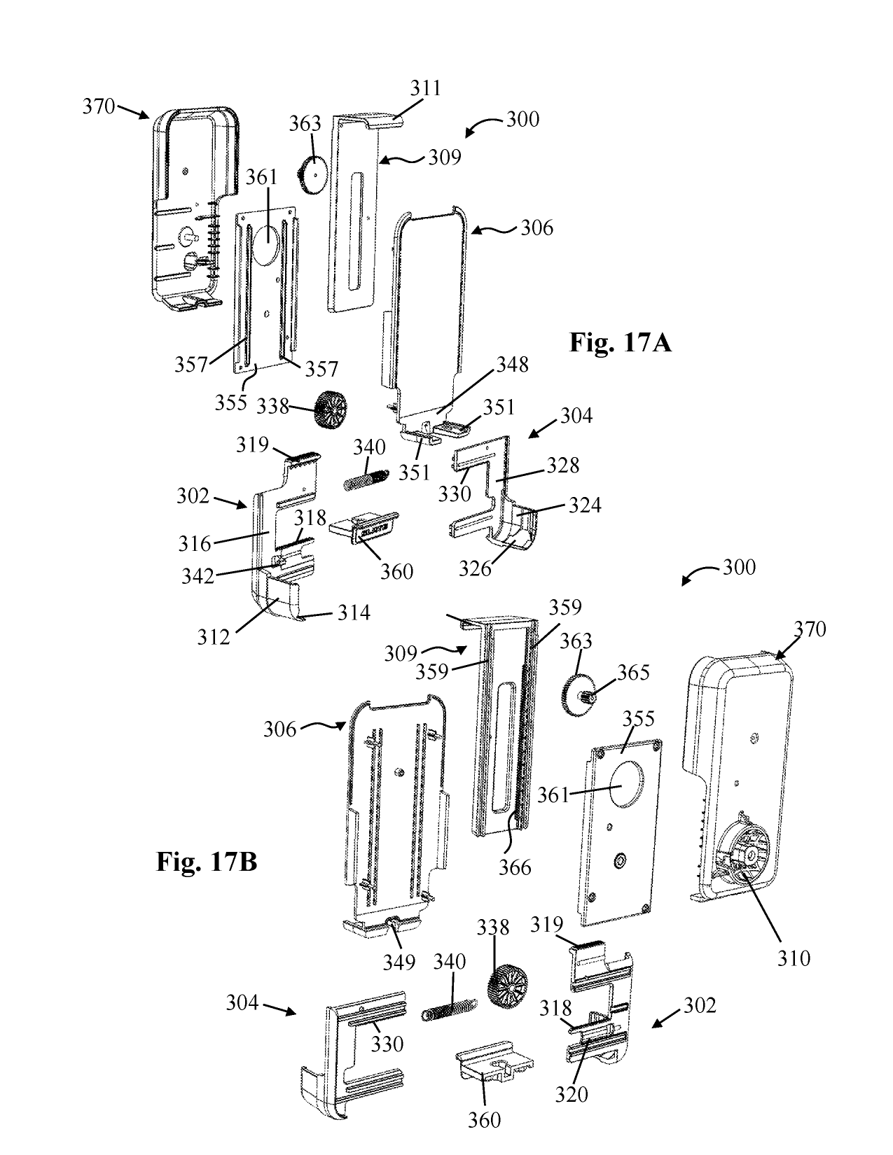

With additional reference to FIGS. 17A and 17B, the left arm 302 has a generally C- or L-shaped configuration defined by an upright extension 312 and a lower extension 314. A back wall 316 extends between and connects the extensions 312, 314. The left arm 302 further comprises a lower gear track 318 (which may be referred to herein as a first gear track) and an upper gear track 319 (which may be referred to herein as a fourth gear track), each comprising a plurality of linear teeth arranged in rack arrangement or configuration for engagement of a gear in a rack-and-pinion configuration. The gear tracks 318, 319 may be arranged substantially parallel to one another. The lower gear track 318 and the upper gear track 319 are configured to engage different gears.

The right arm 304 has a generally C- or L-shaped configuration defined by an upright extension 324 and a lower extension 326. A back wall 328 extends between and connects the extensions 324, 326. The right arm 304 comprises a gear track 330 (which may be referred to herein as a second gear track) comprising linear teeth arranged in rack arrangement or configuration for engagement of a gear in a rack-and-pinion configuration.

A first gear 338 is positioned between the left arm 302 and the right arm 304 and is configured to simultaneously engage the lower gear track 318 of the left arm 302 and the gear track 330 of the right arm 304. Through this rack-and-pinion engagement, linear movement of either the left arm 302 or the right arm 304 causes rotation of the first gear 338, which in turn drives corresponding linear movement of the other arm in an opposite direction, thereby synchronizing lateral movement of the arms 302, 304.

The mobile device holder 300 further comprises a retracting device 340 extending between the left arm 302 and the right arm 304. The retracting device 340 (e.g., a spring) may be secured to the arms 302, 304 via one or more engagement features 342 and may be at least partially received within corresponding recesses or channels (e.g., channel 320 of the left arm 302). The retracting device 340 biases the arms 302, 304 toward one another and is configured to expand and contract during insertion and removal of the mobile device and during opening and closing of the arms.

The support plate 355 includes one or more guiding features 357 configured to engage corresponding guiding features 359 of the upper jaw 309. The guiding features 357, 359 (e.g., ribs and grooves) constrain lateral movement of the upper jaw 309 while permitting substantially linear vertical movement of the upper jaw 309 relative to the support plate 355. The mobile device holder 300 further comprises a support plate 355. The support plate may be fixed relative to the carriage.

The mobile device holder 300 comprises an upper jaw 309. The upper jaw 309 (which may also be referred to as a jaw plate) is configured to move in a substantially linear manner relative to the support plate 355. In particular, the upper jaw 309 may be guided by the guiding features 357, 359 such that movement of the upper jaw 309 is constrained to a vertical direction without substantial lateral movement or tilting.

The upper jaw 309 may comprise an upper finger or tab 311 extending therefrom. The upper finger or tab 311 is configured to engage a top portion of a mobile device when the mobile device is received within the holder 300. In this manner, the upper finger or tab 311 cooperates with the left arm 302 and the right arm 304 to retain the mobile device within the holder 300. For example, the arms 302, 304 may engage opposing side portions of the mobile device while the upper finger or tab 311 engages an upper edge of the mobile device to provide a multi-point retention arrangement.

The upper jaw 309 further comprises a gear track 366 ((which may be referred to herein as a third gear track), which may include a plurality of linear teeth arranged in a rack configuration. The upper jaw 309 may comprise a single gear track 366 or a pair of parallel gear tracks 366. The gear track 366 is configured to engage a gear 363 (e.g., a second gear) in a rack and pinion configuration such that rotation of the gear 363 causes corresponding linear movement of the upper jaw 309 relative to the support plate 355.

The support plate 355 defines an aperture 361 through which the gear 363 extends to engage a gear track 366 formed on the upper jaw 309. The gear 363 is fixed to a gear 365 (e.g., third gear) such that the gears 363,365 rotate together about a common axis. The gear 365 is configured to engage the upper gear track 319 (which may be referred to herein as a fourth gear track) of the left arm 302. Accordingly, linear movement of the left arm 302 drives rotation of the gear 365, which correspondingly rotates the gear 363, thereby translating the upper jaw 309 in a vertical direction via engagement with the gear track 366 on the upper jaw 309.

The carriage 306 may comprise a substantially planar structure configured to support a mobile device thereagainst. The carriage 306 may further comprise an opening 349 at a lower portion thereof, the opening 349 being configured to allow a cable to pass through the carriage 306. The carriage 306 may also comprise one or more engaging features 351 configured to engage a base 360. The one or more engaging features 351 may include, for example, tabs, protrusions, projections, bores, openings, slots, recesses, or other complementary structures configured to cooperate with corresponding features of the base 360. In some configurations, the engaging features 351 and the corresponding features of the base 360 may be arranged to provide alignment, retention, and/or load transfer between the base 360 and the carriage 306.

The mobile device holder 300 may further comprise a base 360 configured to engage a lower region 348 of the carriage 306. The base 360 may be removably coupled to the carriage 306 (e.g., via fasteners, snap-fit features, detents, or sliding interfaces) to enable interchangeability of bases having different configurations, materials, structural properties, and/or aesthetic features. In some configurations, the base 360 may include one or more functional components, such as a connector, plug, or cable interface, thereby allowing the mobile device holder 300 to be adapted for different devices or use conditions.

The mobile device holder 300 further comprises a rear cover 370 that cooperates with the carriage 306 to enclose internal components of the holder 300. The rear cover 370 may be coupled to the carriage 306 such that relative movement between the components is substantially prevented in an assembled configuration. In some embodiments, one or more gears (e.g., gear 338 and/or gears 363, 365) may be rotatably supported on axles that are fixed relative to an interior surface of the rear cover 370.

The mobile device holder 300 further comprises an attaching device 310 configured to engage a corresponding mounting feature (e.g., a slot of an accessory rail) to secure the holder 300 to a vehicle dashboard. The attaching device 310 may be coupled to the rear cover 370 and may include one or more features described with respect to attaching devices disclosed in other embodiments.

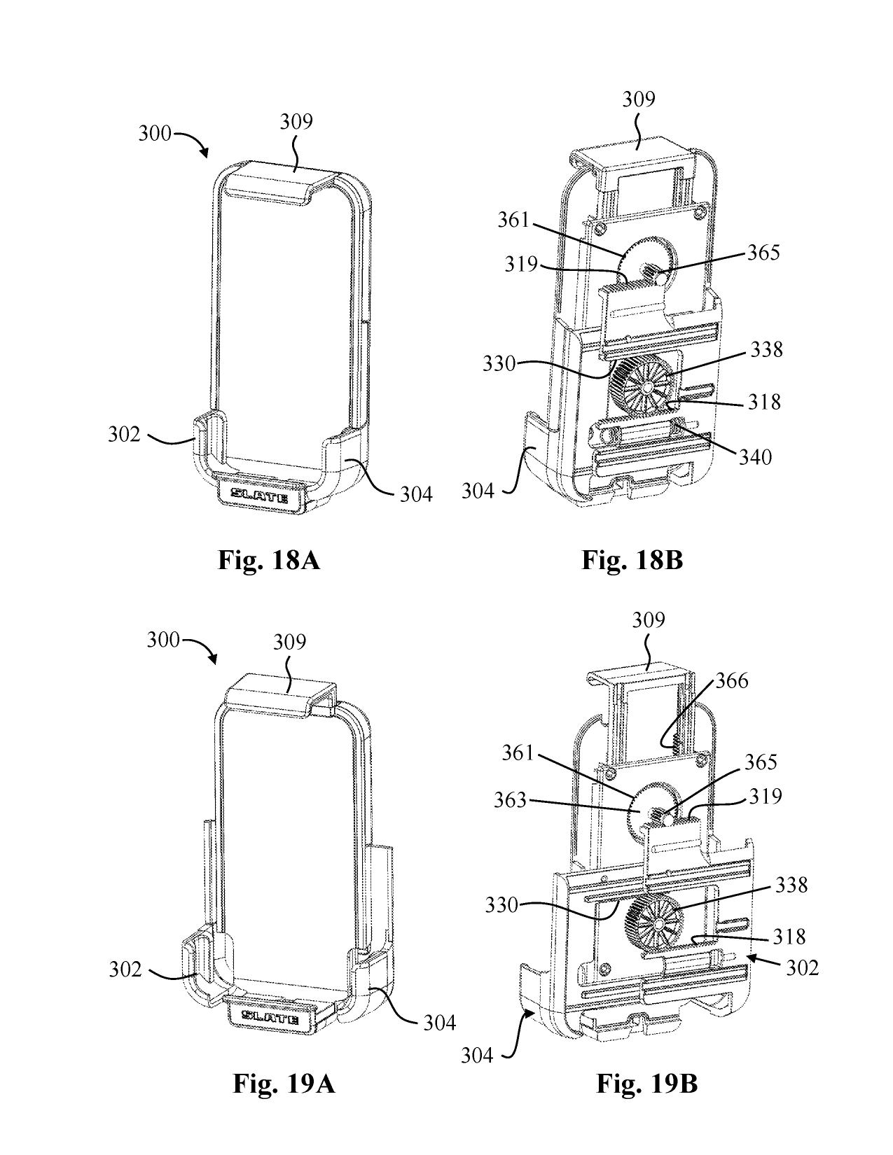

With continued reference to FIGS. 17A–17B and further reference to FIGS. 18A–18B and 19A–19B, the left arm 302, the right arm 304, and the upper jaw 309 are operably coupled such that movement of any one of the arms 302, 304 results in coordinated movement of the other arm and the upper jaw 309. Note that in FIGS. 18B and 19B, the rear cover has been removed to better show the elements of the mobile device holder.

In particular, a first gear 338 is simultaneously engaged with the lower gear track 318 of the left arm 302 and the gear track 330 of the right arm 304. Accordingly, lateral movement of either the left arm 302 or the right arm 304 causes rotation of the first gear 338, which in turn drives corresponding lateral movement of the other arm in an opposite direction, thereby maintaining synchronized motion between the arms 302, 304.

The left arm 302 is further operably coupled to the upper jaw 309 via a coaxial gear assembly. Specifically, the upper gear track 319 of the left arm 302 is engaged with a first gear 365. The first gear 365 is fixed to a second gear 363 such that the gears 365 and 363 are coaxial and rotate together as a unit. The second gear 363 extends at least partially through the aperture 361 of the support plate 355 and engages the gear track 366 of the upper jaw 309. Through this arrangement, lateral movement of the left arm 302 causes rotation of the first gear 365, which correspondingly rotates the second gear 363, thereby translating the upper jaw 309 in a vertical direction.

Because the right arm 304 is coupled to the left arm 302 through the first gear 338, movement of the right arm 304 also results in corresponding movement of the left arm 302. Accordingly, movement of either arm 302, 304 causes rotation of the coaxial gears 365, 363 and resulting vertical movement of the upper jaw 309. In this manner, the arms 302, 304 and the upper jaw 309 are linked in a single kinematic chain such that actuation of any arm produces coordinated motion of all three components.

The retracting device 340 biases the left arm 302 and the right arm 304 toward one another, thereby urging the holder 300 toward a closed or engaged configuration, as shown in FIGS. 18A and 18B. In this configuration, the arms 302, 304 are positioned closer together and the upper jaw 309 is positioned in a lowered position for engaging an upper portion of a mobile device.

When an outward force is applied to either the left arm 302 or the right arm 304 (e.g., during insertion of a mobile device), the engaged gear system causes both arms to move laterally away from one another while simultaneously rotating the coaxial gears 365, 363. This rotation drives the upper jaw 309 upward, thereby transitioning the holder 300 into an open or expanded configuration, as shown in FIGS. 19A and 19B.

Upon release of the outward force, the retracting device 340 contracts, drawing the arms 302, 304 laterally inward toward one another. Through the same gear linkage, inward movement of the arms causes reverse rotation of the coaxial gears 365, 363, thereby driving the upper jaw 309 downward into engagement with the mobile device. In this manner, the arms 302, 304 and the upper jaw 309 cooperate to provide a coordinated, multi-directional clamping mechanism that securely retains the mobile device within the holder 300.

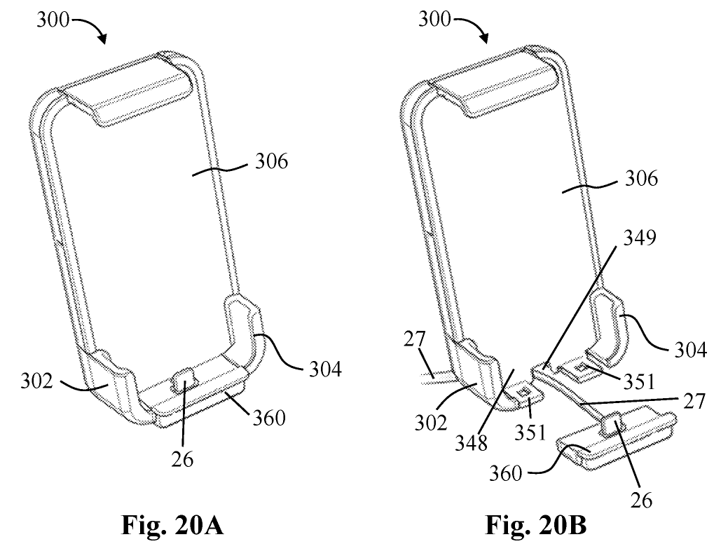

Referring now to FIGS. 20A and 20B, the base 360 may be removably coupled to, or selectively separable from, the carriage 306 and/or one or both of the arms 302, 304.

More specifically, the base 360 may engage one or more engaging features 351 formed on or defined by the carriage 306. The engaging features 351 may include, for example, one or more tabs, protrusions, projections, bores, openings, slots, recesses, or other complementary structures configured to cooperate with corresponding features of the base 360. In some configurations, the engaging features 351 and the corresponding features of the base 360 may be arranged to provide alignment, retention, and/or load transfer between the base 360 and the carriage 306.

In some embodiments, the base 360 may be attached to the carriage 306, the arms 302, 304, and/or the engaging features 351 using one or more fasteners (e.g., screws, bolts, clips), snap-fit features, detents, sliding interfaces (e.g., dovetail or rail-type engagements), or other releasable coupling mechanisms. Such configurations may allow the base 360 to be repeatedly attached and detached without damaging the components, while maintaining sufficient structural integrity during use.

In one configuration, this separability may enable interchangeability of multiple bases 360 having different configurations, materials, structural properties, aesthetic finishes, and/or integrated components such as plugs 26 or cables 27. For example, a first base may include a USB-C plug, while another base may include a Lightning connector, micro-USB connector, wireless charging module, or a base without any electrical connector. In this manner, the mobile device holder may be adapted for use with different mobile devices, vehicle platforms, or user preferences without requiring replacement of the entire holder assembly.

In another configuration, the base 360 may be selectively removed and omitted entirely. This may be desirable in certain implementations where a user prefers to supply power through a separate cable, utilize wireless charging, or accommodate a different connector type that is not integrated into the base 360. Removal of the base 360 may also reduce overall size or simplify the holder for specific use cases.

As shown, the cable 27 may be configured to extend through an opening 349 defined in a lower region 348 of the carriage 306. The opening 349 may be sized and positioned to route the cable 27 from the plug 26 toward a power and/or communication interface located at or near the vehicle dashboard. In some embodiments, the opening 349 may include features such as strain relief structures, guides, or retention elements to manage cable routing and reduce wear. Advantageously, routing the cable 27 through the carriage 306 may conceal at least a portion of the cable from view, thereby improving the aesthetic appearance of the vehicle interior and reducing interference with occupants.

The connector or plug 26 may be oriented at an angle relative to the cable 27. In some configurations, the plug 26 may be arranged at approximately a 90-degree angle relative to the cable 27. This orientation may facilitate engagement between the mobile device and the plug 26 while minimizing downward bending or sagging of the cable 27. For example, positioning the plug at an angle may reduce the likelihood that the cable extends below the mobile device holder 300, which may otherwise occur if the plug 26 were aligned in a generally straight (e.g., 0-degree) configuration with the cable 27. This arrangement may improve cable management, reduce stress on the connector interface, and enhance overall usability.

The mobile device according to these teachings may be configured for use with one or more land-based vehicles, such as passenger cars, trucks, sport utility vehicles (SUVs), vans, buses, motorcycles, all-terrain vehicles (ATVs), utility task vehicles (UTVs), side-by-side vehicles, recreational vehicles (RVs), construction vehicles, agricultural vehicles, and trailers. In other configurations, the vehicle may include watercraft (e.g., boats, personal watercraft, ships, and other marine vessels) and aircraft (e.g., airplanes, helicopters, drones, and other aerial vehicles). The disclosed concepts may further be applied to other transport or recreational platforms, regardless of propulsion type or operating environment.

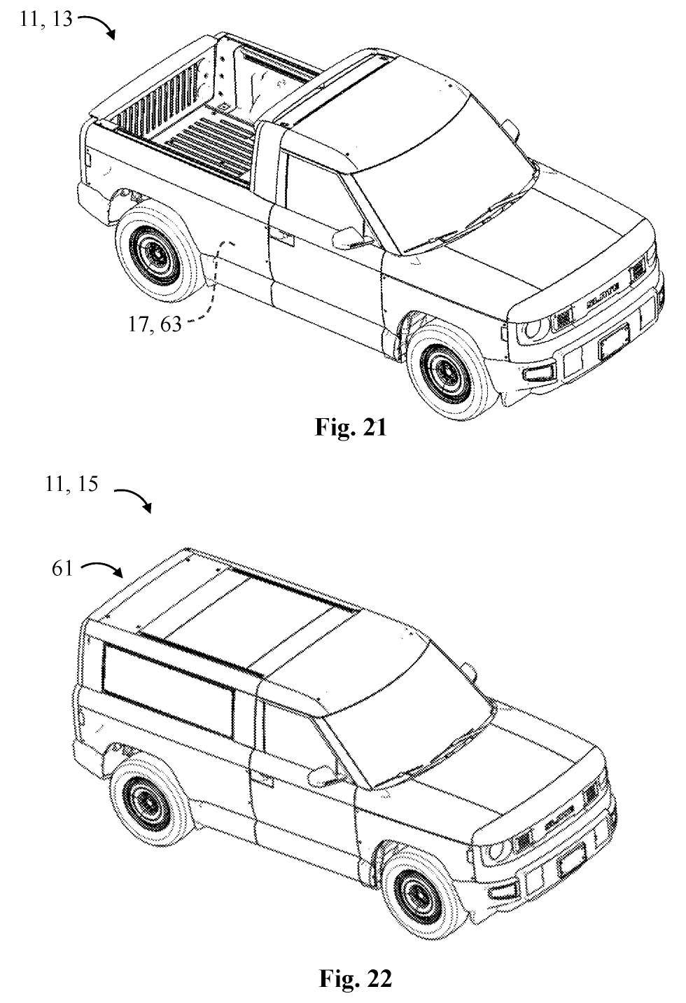

FIGS. 21 and 22 illustrate an example of a vehicle 11 that is reconfigurable between a pickup truck configuration 13 and a sport utility vehicle (SUV) configuration 15. The vehicle includes a vehicle frame 17 configured to support both the pickup truck configuration 13 and the SUV configuration 15 and to allow reconfiguration therebetween without permanently modifying the vehicle frame 17. The vehicle may be reversibly reconfigurable between the two configurations or vehicle states 13, 15. The vehicle 10 may include a dashboard, like the one illustrated in FIG. 1. The mobile device holder according to these teachings may be used with such a vehicle 11.

A rear enclosure assembly 61 may be attached to one or more preexisting fasteners 63 on the vehicle frame 17 to reconfigure the vehicle 11 from the pickup truck configuration 13 to the SUV configuration 15. The use of the preexisting fasteners 62 enables installation without drilling, welding, cutting, or otherwise permanently altering the vehicle frame 17. As used herein, “preexisting” refers to fastening features incorporated into or on the vehicle frame by the original vehicle manufacturer during original manufacture and prior to the vehicle being placed into service.

As used herein, “preexisting” refers to fastening features incorporated into or on the vehicle frame by the original vehicle manufacturer during original manufacture and prior to the vehicle being placed into service. For example, the plurality of preexisting frame fastening devices comprise threaded fasteners, weld nuts, threaded bores, or combinations thereof installed prior to reconfiguration of the vehicle. The rear enclosure assembly is attachable to the vehicle frame without welding, bonding, cutting, drilling, or grinding the vehicle frame. The rear enclosure assembly is removable from the vehicle frame to return the vehicle to the pickup truck configuration using the plurality of preexisting frame fastening devices.

The rear enclosure assembly 61 may include a roll bar assembly, a hoop structure defined by opposing pillars and at least one cross bar extending therebetween, and a rear seat assembly. One or more of these components may be attached to the vehicle frame 14 via the preexisting fasteners 17 such that occupant loads from the rear seat assembly are transferred to the vehicle frame 17. In some configurations, the roll bar assembly and associated structure are configured to provide defined load paths and structural performance sufficient to comply with applicable federal crash and rollover standards.

Further aspects of the vehicle 10, the one or more configurations or states 13,15, the rear enclosure assembly 61, and elements thereof are disclosed in U.S. Patent Application No. 19/642,294 filed on Apr. 08, 2026, the entirety of which is incorporated herein by reference.

In some configurations, the vehicle may be reconfigurable or reversibly configurable between different vehicle configurations. In some embodiments, the vehicle may be reconfigured from a first vehicle configuration to a second vehicle configuration. The vehicle can be reconfigured back to the first vehicle configuration. In other words, the vehicle has a reversible configurable structure. The vehicle can be reconfigured or reversibility configured between a pickup truck configuration and a sport utility vehicle (SUV) configuration.

In the context of the present description, “reversibly configurable” refers to structure having ability to be reconfigured (e.g., converted or transformed) from a first configuration to a second configuration and back to the first configuration. In this regard, “reversibly configurable” includes an ability of a structure to be reconfigured without permanently altering the structure in a way that would inhibit the structure from being reconfigured back to a previous configuration. For example, the structure may be reversibly configured from and/or between the first vehicle configuration to a second vehicle configuration without using permanent fasteners like adhesives or welding. For example, the structure may be reversibly configured from and/or between a first vehicle configuration to a second vehicle configuration without the need for using destructive material removal techniques causing permanent deformation such as cutting, milling, grinding, etc.

However, in some configurations, if drilling other insignificant plastic deformation is required to reconfigure the vehicle from or between the first and second vehicle configuration, such drilling is minimal and in accordance with an instruction approved by the original equipment manufacturer so that it avoids compromising structural integrity of the frame, and/or does not interfere with design and/or performance specifications of the original equipment manufacturer. For example, “reversibly configurable” includes an ability of a structure to be reconfigured with only limited drilling of openings in a vehicle structure, such as to receive a fastener in the transformed configuration. However, such drilling of openings does not prevent the structure from being converted or transformed back into a previous configuration.

The conversion of the vehicle from and/or between a first configuration and a second configuration according to these teachings may be accomplished or achieved by using non-permanent mechanical connections (e.g., mechanical fasteners, mechanical interlocks, bolts, screws, weld nuts, clamps, and/or friction fits). In this way, the reconfiguration may not permanently alter any of the vehicle components such that the vehicle components could not be returned to the previous configuration.

Advantageously, by utilizing non-permanent mechanical connections to add, remove, or reposition vehicle components during the reconfiguration or conversion, end users without access to complicated tools, machinery, and/or fabricating techniques can reconfigured the vehicle. Instead, common tool such as sockets, ratchets, wrenches, screw drivers, and the like can be used to reconfigure the vehicle, without the need for complicated and expensive tools, machinery, and/or fabricating techniques, such as, for example grinders, cutters, welders, etc.

The conversion of the vehicle from the first configuration to the second configuration may be performed after the vehicle has been placed in service by the original equipment manufacturer (OEM) In other words, the OEM may manufacture and offer the vehicle for sale in the first vehicle configuration as original equipment. Then, if a user desires the second vehicle configuration, the user may obtain the rear enclosure assembly and reconfigure the vehicle structure from the original equipment into the second vehicle configuration according to these teachings. The user can also reconfigure the vehicle back to the first vehicle configuration at a later time due to the reversibly configurable nature of the vehicle according to these teachings.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of "a" or "one" to describe an element or step is not intended to foreclose additional elements or steps. For example, disclosure of “a motor” does not limit the teachings to a single motor. Instead, for example, disclosure of “a motor” may include “one or more motors.”

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The invention illustratively disclosed herein suitably may be practiced in the absence of any element which is not specifically disclosed herein.

Any of the elements, components, regions, layers and/or sections disclosed herein are not necessarily limited to a single embodiment. Instead, any of the elements, components, regions, layers and/or sections disclosed herein may be substituted, combined, and/or modified with any of the elements, components, regions, layers and/or sections disclosed herein to form one or more embodiments that may not be specifically illustrated or described herein.

The disclosures of all articles and references, including patent applications and publications, testing specifications, are incorporated by reference for all purposes. Other combinations are also possible as will be gleaned from the following claims, which are also hereby incorporated by reference into this written description.

1. A mobile device holder for attaching a mobile device to an accessory rail on a vehicle dashboard of a vehicle, the mobile device holder comprising:
a left arm comprising a first gear track;
a right arm comprising a second gear track;
a carriage positioned between the left arm and the right arm and configured to support a rear surface of the mobile device;
a first gear engaged with the first gear track and the second gear track such that linear movement of one of the left arm or the right arm causes corresponding linear movement of the other of the left arm or the right arm;
a retracting device coupled to the left arm and the right arm and configured to bias the left arm and the right arm toward one another;
an upper jaw configured to move linearly relative to the carriage;
a second gear engaged with a third gear track of the upper jaw;
a third gear fixed to the second gear such that the second gear and the third gear rotate together, the third gear being engaged with a fourth gear track of the left arm such that movement of either the left arm or the right arm causes corresponding movement of the upper jaw; and
an attaching device configured to engage the accessory rail.

2. The mobile device holder of claim 1, wherein the first gear track, the second gear track, the third gear track, and the fourth gear track each comprise linear teeth configured for rack-and-pinion engagement.

3. The mobile device holder of claim 1, wherein the first gear is simultaneously engaged with the first gear track and the second gear track.

4. The mobile device holder of claim 1, wherein the second gear and the third gear are coaxial and fixed to rotate about a common axis.

5. The mobile device holder of claim 1, wherein the third gear track of the upper jaw is arranged such that rotation of the second gear causes vertical translation of the upper jaw.

6. The mobile device holder of claim 1, further comprising a support plate including guiding features configured to constrain movement of the upper jaw to a linear path.

7. The mobile device holder of claim 6, wherein the guiding features comprise ribs and grooves.

8. The mobile device holder of claim 1, wherein the retracting device comprises a spring configured to bias the left arm and the right arm toward a closed configuration.

9. The mobile device holder of claim 1, wherein the upper jaw comprises a tab configured to engage an upper portion of the mobile device.

10. The mobile device holder of claim 1, wherein the carriage defines an aperture through which the second gear extends to engage the third gear track of the upper jaw.

11. The mobile device holder of claim 1, wherein the attaching device further comprises a key operably coupled to the cam, the key being actuatable to move the cam between (i) a locked position in which the cam engages one or more walls of the slot of the accessory rail to secure the mobile device holder to the accessory rail, and (ii) an unlocked position in which the cam is disengaged from the one or more walls of the slot to permit repositioning of the mobile device holder along the accessory rail or removal of the mobile device holder from the accessory rail.

12. The mobile device holder of claim 11, further comprising an articulating device including a ball and socket joint, wherein the ball is at least partially received within the socket to permit rotation of the mobile device holder relative to the attaching device about one or more axes to adjust an orientation of the mobile device.

13. A mobile device holder for attaching a mobile device to an accessory rail on a vehicle dashboard, the mobile device holder comprising:
a left arm comprising a lower gear track and an upper gear track, the lower gear track and the upper gear track each comprising linear teeth arranged in a rack configuration;
a right arm comprising a gear track comprising linear teeth arranged in a rack configuration;
a carriage positioned between the left arm and the right arm and configured to support a rear surface of the mobile device;
a first gear simultaneously engaged with the lower gear track of the left arm and the gear track of the right arm such that linear lateral movement of either the left arm or the right arm causes rotation of the first gear and corresponding linear lateral movement of the other arm;
a retracting device coupled between the left arm and the right arm and configured to bias the arms toward one another;
a support plate fixed relative to the carriage and comprising guiding features;
an upper jaw configured to move linearly in a vertical direction relative to the support plate and constrained by the guiding features to prevent tilting, the upper jaw comprising a gear track;
a second gear engaged with the gear track of the upper jaw;
a third gear fixed coaxially with the second gear such that the second gear and the third gear rotate together about a common axis, the third gear being engaged with the upper gear track of the left arm;
wherein movement of either the left arm or the right arm causes rotation of the first gear, corresponding movement of the left arm, rotation of the third gear and the second gear, and vertical movement of the upper jaw; and
an attaching device comprising a cam configured to engage a slot of the accessory rail.

14. The mobile device holder of claim 13, wherein the support plate defines an aperture through which the second gear extends to engage the gear track of the upper jaw.

15. The mobile device holder of claim 13, wherein the upper jaw comprises a tab configured to engage an upper edge of the mobile device, and the left arm and the right arm are configured to engage opposing side portions of the mobile device to provide multi-point retention.

16. The mobile device holder of claim 13, further comprising a rear cover coupled to the carriage, wherein the first gear, the second gear, and the third gear are supported on axles fixed relative to the rear cover.

17. The mobile device holder of claim 13, further comprising a base removably coupled to a lower region of the carriage and configured to engage one or more engaging features of the carriage, the base including a connector coupled to a cable..

18. The mobile device holder of claim 17, wherein the connector is oriented at an angle of about 90 degrees relative to the cable

19. The mobile device holder of claim 13, wherein the attaching device further comprises a key operably coupled to the cam, the key being actuatable to move the cam between (i) a locked position in which the cam engages one or more walls of the slot of the accessory rail to secure the mobile device holder to the accessory rail, and (ii) an unlocked position in which the cam is disengaged from the one or more walls of the slot to permit repositioning of the mobile device holder along the accessory rail or removal of the mobile device holder from the accessory rail.

20. The mobile device holder of claim 18, further comprising an articulating device including a ball and socket joint, wherein the ball is at least partially received within the socket to permit rotation of the mobile device holder relative to the attaching device about one or more axes to adjust an orientation of the mobile device.
